(19) United States
(12) Patent Application Publication
(10) Pub. No.: US 2022/0258237 A1
(43) Pub. Date: Aug. 18, 2022

(54) THREE DIMENSIONAL PRINTING OF CERMET OR CEMENTED CARBIDE

(71) Applicant: SANDVIK MACHINING SOLUTIONS AB, Sandviken (SE)

(72) Inventors: John DE FLON, Sandviken (SE); Bartek KAPLAN, Alunda (SE)

(21) Appl. No.: 17/624,832

(22) PCT Filed: Jun. 23, 2020
(86) PCT No.: PCT/EP2020/067471

§ 371 Date: Jan. 4, 2022

(30) Foreign Application Priority Data
Jul. 5, 2019 (EP) 19184679.9

(51) Int. Cl. B22F 10/14; B33Y 10/00; B33Y 40/10; B33Y 40/20; B22F 10/68; B22F 1/10; B22F 9/02; B22F 9/04

(52) U.S. Cl. CPC B22F 10/14; B33Y 10/00; B33Y 40/10; B33Y 40/20; B22F 2302/10; B22F 1/10; B22F 9/026; B22F 9/04; B22F 2301/15; B22F 10/68

(57) ABSTRACT

A method of making a 3D printed cermet or cemented carbide body including a hard phase and a metallic binder phase whereby the 3D printed green body is subjected to a sintering process including a holding step prior to a liquid phase sintering step. The sintered bodies have a reduced porosity.

### TECHNICAL FIELD

The present invention relates to a method of three dimensional printing of a cermet or cemented carbide sintered body.

### BACKGROUND ART

Three dimensional (3D) printing or additive manufacturing is a promising manufacturing technique that makes it possible to print a three dimensional body. A model of the body is typically created in a computer program and this model is then printed in a three dimensional printing machine or apparatus. Three dimensional printing is a promising manufacturing technique because it makes it possible to produce complex structures and bodies that cannot be achieved via conventional manufacturing processes.

One type of three dimensional printing is based on binder jetting wherein an ink jet type printer head is used to spray binder onto a thin layer of powder, which, when set, forms a sheet of glued together powder for a given layer of an object. After the binder is set, a next thin layer of powder is spread over the original layer, and the printed jetting of binder is repeated in the pattern for that layer. The powder that was not printed with the binder remains where it was originally deposited and serves as a foundation and as support for the printed structure. When printing of the object is complete, the binder is cured at an increased temperature and subsequently the powder not printed with binder is removed by for example an air stream or brushing.

Cermet and cemented carbide materials consist of hard constituents of carbides and/or nitrides such as WC or TiC in a metallic binder phase of for example Co. These materials are useful in high demanding applications due to their high hardness and high wear resistance in combination with a high toughness. Examples of areas of application are cutting tools for metal cutting, drill bits for rock drilling and wear parts.

One of the challenges when producing cermet and cemented carbide materials using three dimensional printing is to provide a body with comparable microstructure, i.e. porosity, minimum of Co islands etc. as conventionally produced cermet and cemented carbide materials, i.e. formed by pressing.

One challenge when sintering three dimensional printed cermet and cemented carbide green bodies is that the powders used for printing are usually already pre-sintered whereas the powders used in conventionally produced cermet and cemented carbide materials, i.e. green bodies formed by pressing, has not been pre-sintered. This will have a big impact on the sintering behavior and sintering three dimensional printed cermet and cemented carbide green bodies is not easy and defects as porosity, Co islands and abnormal grain growth are common.

One way to decrease the defects is to use sinter-HIP, which includes a first liquid phase sintering step, usually performed during vacuum, and a second high pressure step. However, although it is possible to provide fairly good cermet and cemented carbide materials using sinter HIP, it places high demands on the powder quality.

In WO2017/178084 a reduction of porosity after sintering is achieved by using a powder having a large fraction of fines (<10 μm).

However, a powder with a large fraction of fines will lead to reduced flowability which can cause problems during the handling of the powder as well as during the printing process.

There is a need to find a successful method of making three dimensional printed cermet and cemented carbide bodies that is homogeneous in structure and in composition with a minimal density of pores without having to use a powder with a high amount of fine fraction etc. which can cause problems during handling and sintering.

### DETAILED DESCRIPTION OF THE INVENTION

It is an objective of the present invention to provide a method of making a three dimensional (3D) printed cermet or cemented carbide body with a homogeneous composition and with a minimum of pores after sintering.

It is an objective of the present invention to provide a process that is suitable to use when making three dimensional printing of cermet or cemented carbide bodies.

At least one of these objects is achieved with a process according to claim 1. Preferred embodiments are listed in the dependent claims.

The present invention relates to a method of making a 3D printed cermet or cemented carbide body comprising a hard phase and a metallic binder phase, said method comprising the steps of:
providing a ready-to-print powder comprising cermet or cemented carbide particles,
3D printing a body using said ready-to-print powder together with a printing binder and thereby form a 3D printed cermet or cemented carbide green body
sintering said green body in a sintering process comprising a liquid phase sintering step at a temperature for liquid phase sintering, wherein the sintering process comprises at least one holding step prior to the liquid phase sintering step, wherein the duration of the holding step is between 30 and 500 minutes and the temperature for the holding step is between 1200 and (Tₘ−10)° C., where Tₘ is the temperature when the metallic binder phase starts to melt for the specific cermet or cemented carbide composition.

Liquid phase sintering is performed at a temperature above the temperature for when the metallic binder in a particular cermet or cemented carbide composition melts. Preferably, the liquid phase sintering takes place at a temperature between 1350 and 1500° C. preferably, the duration for the liquid phase sintering is between 30 and 300 minutes, more preferably between 30 and 120 minutes.

The liquid phase sintering step is preferably performed in vacuum, i.e. so-called vacuum sintering. By that is herein meant that the pressure is below 0.5 mbar.

Liquid phase sintering step is common in the art of sintering cermets and cemented carbides and usually contains a debinding step prior to reaching the liquid phase sintering temperature, usually at a temperature of between 200 and 550° C. for about 30 and 120 minutes. The debinding step is performed in order to remove any residual binder, e.g. gluing printing binder. The printing binder comprises a solvent that partly evaporates during the printing. The printing binder can be water-based.

In conventional liquid phase sintering, the temperature is then increased to the sintering temperature, which usually are between 1350 to 1500° C., where the liquid phase sintering takes place.

In one embodiment of the present invention, the liquid phase sintering step is divided into two steps, where there is a pre-sintering step, in the lower part of the liquid phase sintering region, at a temperature between Tₘ and (Tₘ+50), preferably between 1310 and 1330° C. prior to increasing the temperature to the final liquid phase sintering temperature. Tₘ is the temperature where the metallic binder phase starts to melt for a specific cermet or cemented carbide composition. The duration of the pre-sintering step is preferably between 30 and 90 minutes.

According to the present invention, there is a holding step in between the debinding step and the liquid phase sintering step, i.e. a solid state sintering step. The holding step is between 30 and 500 minutes, preferably between 45 and 300 minutes, more preferably between 90 and 120 minutes and the holding temperature is 1200 and (Tₘ−10)° C., where Tₘ is the temperature when the binder starts to melt for a specific cermet or cemented carbide composition, preferably the holding temperature is between 1200 and 1300° C.

By holding step, is herein meant that the temperature is kept between 1200 and (Tₘ−10)° C., for the whole duration of the holding step, the temperature can increase/decrease either continuously or stepwise as long as the temperature is between 1200 and (Tₘ-10)° C. Preferably, the temperature is the same temperature during the whole holding time.

The temperature for when a particular binder phase composition starts to melt, is different for each specific cermet or cemented carbide composition. The temperature, Tₘ is dependent on e.g. the amount of binder and other elements that may dissolve in the binder as e.g. W, C, Cr, Ti, Ta, Nb etc. Usually, the metallic binder phase starts to melt below the melting point found in literature for the pure metal in the binder, e.g. Co.

The holding step helps to further consolidate the body and reducing the amount of pores prior to the liquid phase sintering.

In one embodiment of the present invention, the sintering process further comprises, after the liquid phase sintering step, a step of high pressure sintering, also called sinter-HIP or GPS (gas pressure sintering) of the cermet or cemented carbide body. The high pressure sintering may be performed at a temperature of 1300-1500° C. and at a pressure of 20-100 bar. The aim of the high pressure step is to reduce any porosity left after the sintering by densifying the material. Any closed porosity in the sintered body is encapsulated and the applied pressure will reduce the porosity. Open porosity can on the other hand not be reduced using sinter-HIP.

In one embodiment of the present invention, the sintering process can be performed in two separate steps, usually in different furnaces. The liquid phase sintering step, incl. a holding step prior to reaching the temperature for liquid phase sintering is then performed in one furnace and thereafter the sintered bodies is cooled down before placed in a second furnace where the pieces are yet again heated to a temperature for liquid phase sintering before the high pressure step takes place.

In yet another embodiment of the present invention, the sintering process comprising a liquid phase sintering step and a high pressure step, is performed as two subsequent steps in the same sintering process and also in the same furnace. There are several advantages with such a combined sintering process. First, there is no need for waiting for the pieces to cool down and also there is no need to transport them between furnaces. Secondly, combining the two steps, minimizes the time above the temperature for liquid phase sintering which leads to minimized WC grain growth.

After sintering, a step of grinding or polishing the body can be added as a final step after the sintering step.

The ready-to-print powder used in the method of making a three dimensional printing of a cermet or cemented carbide body, can be any powder comprising cermet or cemented carbide particles suitable for three dimensional printing.

By cermet or cemented carbide particles is herein meant that the particles have been pre-sintered. By pre-sintered it is herein meant that the powder has been sintered, such as using solid state sintering and/or liquid phase sintering.

Preferably, the ready-to-print powder is a pre-sintered powder comprising spherical cermet or cemented carbide particles with good flowability.

The cemented carbide and/or cermet particles of the ready-to-print powder of the present invention comprise a relatively low fraction of fine particles. These fine particles are milled to its fine size and the milling also implies that the fine particles are irregular in shape, i.e. they are typically not spherical. An advantage with these particles is that the powder bed formed during printing is stable.

The D90 of the particles in the ready-to-print powder is 15-40 μm, preferably 17-35 μm, more preferably 27-33 μm. This is advantageous in that it provides a powder with good flow during printing and decreased risk for problems related to metallic binder phase enriched zones. Too large particles tend to contribute in the formation of metallic binder phase enriched zones in the sintered cermet or cemented carbide body. The sintered cermet or cemented carbide body ideally consists of a material composed of hard constituents such as WC in a metallic binder phase such as Co, wherein the metallic binder phase is evenly or homogeneously distributed inside the body and wherein any metallic binder phase enriched zones homogeneously or evenly distributed.

In one embodiment of the present invention the D50 of the cemented carbide and/or cermet particles is 5-35 μm, preferably 10-30 μm, more preferably 15-25 μm, most preferably 17-21 μm.

In one embodiment of the present invention the D10 of the cemented carbide and/or cermet particles is 1-25 μm, preferably 5-15 μm, more preferably 5-10 μm.

In one embodiment of the present invention the particle size distribution of the cemented carbide and/or cermet particles in the powder is unimodal. This is advantageous in that the powder can be milled to reach a preferred particle size distribution.

In one embodiment of the present invention, the ready-to-print powder comprises between 10 and 70 vol %, preferably between 10 and 25 vol %, preferably between 13 and 20 vol %, particles with a diameter <10 μm. If the fine fraction is larger, the flow of the powder during printing will be uneven and demanding.

In one embodiment of the present invention, the ready-to-print powder has been pre-sintered so that the porosity of the cermet or cemented carbide particles is between 0 to 40% porosity, preferably between 10-40 vol %, or 15-30 vol %, or 17-30 vol % or 15-25 vol %.

In one embodiment, the ready-to-print powder has been pre-sintered so that the porosity of the cermet or cemented carbide particles is between 0 to 20% porosity, preferably between 0-10 vol %, or 0-5 vol %, or that the particles are fully dense.

The porosity contributes to the sintering activity during the sintering of the printed green body and depending on how much sintering activity that is desired for a particular cermet or cemented carbide composition, the porosity can be adjusted. The porosity can for example be measured in a LOM at 1000× magnification.

If the porosity of the particles is too high the green body will be relatively fragile. The reason to causing the green body to be fragile is probably that capillary forces cause a sucking up of printing binder into the porous particles, leaving less printing binder at the surface of each porous particle and thereby causing a weaker connection between particles.

In one embodiment of the present invention, the ready-to-print powder is made by:
mixing a cermet or cemented carbide raw powder and organic binder
spray drying said raw powder and thereby form a granulated raw powder
pre-sintering said spray dried raw powder removing said organic binder and thereby—form a pre-sintered granulated powder,
milling said pre-sintered granulated powder until the desired particle size distribution is achieved and thereby form a ready-to-print-powder.

In one embodiment of the present invention the spray dried powder is sieved before the pre-sintering step, preferably sieved to remove particles larger than 42 μm in diameter. This is advantageous in that it reduces the risk of problems with very large particles in the powder.

In one embodiment of the present invention the cermet and/or cemented carbide particles comprise a metallic binder phase and wherein the average content of metallic binder phase in the powder is 5-14 wt %, preferably 8-13 wt % or 10-13 wt %. The metallic binder phase content is herein calculated excluding the organic binder, based on only hard constituents and metallic binder content in powder. A metallic binder phase content within this range is advantageous in that the density of pores in the sintered cermet or cemented carbide body may be very limited and still the body can gain from the hardness and toughness that is characteristic for a cermet or cemented carbide body. It is usually easier to produce a pore free body with a higher content of metallic binder phase since it is this phase that is melting during liquid phase sintering. The cermet or cemented carbide also typically comprises hard constituents. These hard constituents are ceramic and can for example be TiN, TiCN, TiC and/or WC in any combination.

In one embodiment of the present invention the ready-to-print powder comprises cemented carbide particles. The cemented carbide particles comprise WC with an average grain size of 0.5-5 μm or 0.5-2 μm. Preferably more than 90 wt % of the hard constituents are WC.

In one embodiment of the present invention the ready-to-print powder comprises cemented carbide particles comprising a Co binder phase in an amount of 5-14 wt %.

In one embodiment the three dimensional printing is performed in a three dimensional printing machine such as a binder jet three dimensional printing machine.

In one embodiment of the present invention the three dimensional printing is a binder jetting. Binder jetting is advantageous in that it is a relatively cheap three dimensional printing method.

In one embodiment of the present invention the method further comprise, subsequent to 3D printing and before sintering, the steps of:
curing the 3D printed body in inert atmosphere at 150-230° C., and
depowdering the 3D printed body to remove loose particles from the surfaces of the body.

Curing is normally performed as a part of the printing step. The printing binder is cured whereby the green body gets a sufficient green strength. The curing can be performed by subjecting the printed green body to an increased temperature, such as 150-250° C. before removal of the excessive powder. In one embodiment the curing is performed in a non-oxidation environment such as in Ar or N₂ or in vacuum.

The three dimensional printing of a cermet or cemented carbide body may result in a body of any shape suitable for its purpose. Cermet and the cemented carbide both comprise hard constituents in a metallic binder phase. In the case of cemented carbide, at least a portion of the hard constituents consists of WC. The number and size of pores in the three dimensional printed and sintered cermet or cemented carbide body is preferably lower than A06 and/or B06 as defined in ISO 4499-4:2016, preferably lower than A04 and/or B04 more preferably lower than A02 and/or B02. The number and size of pores in the three dimensional printed and sintered cermet or cemented carbide body is preferably lower than A02B00C00, A00B02C00 or A02B02C00. Most preferably no pores, i.e. a porosity of A00B00C00, are present in the three dimensional printed and sintered cermet or cemented carbide body.

In one embodiment of the present invention the 3D printed body is a cutting tool for metal cutting such as an insert, a drill or an end mill.

In one embodiment of the present invention the 3D printed body is a cutting tool for mining application such as a drill bit, or a wear part.

### DEFINITIONS

The term “cermet” is herein intended to denote a material comprising hard constituents in a metallic binder phase, wherein the hard constituents comprise carbides or carbonitrides of one or more of Ta, Ti, Nb, Cr, Hf, V, Mo and Zr, such as TiN, TiC and/or TiCN.

The term “cemented carbide” is herein intended to denote a material comprising hard constituents in a metallic binder phase, wherein the material comprise more than 50 wt % WC. The hard constituents can also comprise carbides or carbonitrides of one or more of Ta, Ti, Nb, Cr, Hf, V, Mo and Zr, such as TiN, TiC and/or TiCN.

The metallic binder phase in the cermet or in the cemented carbide is a metal or a metallic alloy, and the metal can for example be selected from Cr, Mo, Fe, Co or Ni alone or in any combination. Preferably the metallic binder phase comprises a combination of Co, Ni and Fe, a combination of Co and Ni, or only Co. The metallic binder phase can comprise other suitable metals as known to the skilled person.

The particle sizes distribution is herein presented by D10, D50 and D90 values. The D50, the median, is defined as the particle diameter where half of the population has a size smaller than this value. Similarly, 90 percent of the distribution is smaller than the D90 value, and 10 percent of the population is smaller than the D10 value.

Embodiments of the present invention will be disclosed in more detail in connection with the following examples. The examples are to be considered as illustrative and not limiting embodiments.

### EXAMPLE 1

Powders of Co, Cr and WC were mixed to form a cemented carbide raw powder. Also PEG was added to this raw powder. The composition was 12.79 wt % Co, 0.58 wt % Cr and balance WC (PEG not included).

As a next step spray drying of said raw powder was performed forming spherical granules of WC, Co, Cr and PEG. This powder of spray dried granules was sieved to remove granules larger than 42 μm in diameter.

The spray dried granules were then pre-sintered to remove the PEG but keep a residual porosity in the pre-sintered granules. The pre-sintering was performed for 1 hour at 1250° C. for powders A1 and A2 and at 1230° C. for powder B1. The pre-sintering resulted in a cake of pre-sintered granules, i.e. of cemented carbide particles.

The porosity of the cemented carbide particles was analyzed by studying a through-cut of several particles. Particles were embedded in bakelite and polished and an image analysis was made using ImageJ at 1000× magnification.

The powder of cemented carbide particles was then divided into different fractions where three fractions were milled for different period of times in a 30 liter ball mill, see Table 1. 60 kg cemented carbide cylpebs and 1.5 L ethanol were used.

The particle size distribution (D10, D50 and D90) and the fraction of the particles with a diameter <10μm were analyzed with Sympatec HELOS/BR Particle size analysis with laser diffraction and RHODOS dry dispersing system. The results are presented in Table 1.

TABLE 1
Powders

| | Milling | | | | Vol % < | Powder |
|---|---|---|---|---|---|---|
| | time | D10 | D50 | D90 | 10 μm | porosity |
| Powder | (minutes) | (μm) | (μm) | (μm) | (vol %) | (vol %) |
| A1 | 45 | 7.32 | 19.69 | 31.35 | 15.1 | n.a. |
| A2 | 60 | 5.90 | 18.43 | 29.68 | 18.4 | n.a. |
| B1 | n.a. | 5.5 | 20 | 35 | 20 | 15 |

Printing was performed in a binder jetting printing machine with a layer thickness during printing of 100 μm. The printing of powders A1 and A2 was done in a “ExOne Innovent”. Saturation during printing was 110%. Powder B1 was printed in a binder jetting printing machine “ExOne X1-Lab” with a saturation of between 90-97%.

The saturation of printing binder is defined as the percent of the void volume that is filled with printing binder at a specified powder packing density (here the powder packing density is set to 60%). A higher saturation is needed when printing with a powder comprising a larger fraction of porous particles as compared to a lower fraction of porous particles.

Water based printing ink X1-Lab™ Aqueous Binder (7110001CL) was used as printing binder. During the printing the sequence for each layer was as follows: a 100 μm layer of the powder was spread over the bed, printing binder was spread in a pattern as defined in a CAD model, followed by drying of the printing binder to remove the solvent of the printing binder. This was repeated until the full height of the green body was printed. Thereafter curing was done overnight at 200° C. in vacuum. Depowdering was done manually by brush and pressurized air.

The printed and cured green bodies were subsequently sintered in a sintering process.

Powders A1 and A2 was sintered in a sintering process comprising a liquid phase sintering step and a high pressure step, to provide sintered cemented carbide samples (bodies). The sintering was done at Y-coated graphite trays in a HEK45 sintering furnace. First, the bodies were subjected to a debinding step where the temperature was increased from room temperature up to 550° C. in a sintering chamber with a H2 flow of 500 I/hour. This was followed by a vacuum step where the temperature was increased from 550° C. to 1270° C. where it was hold for 120 minutes, i.e. the holding step. Thereafter, the liquid phase was initiated by increasing the temperature to 1320° C. where it was hold for 60 minutes followed by sintering at 1410° C. for 60 minutes. After the liquid phase sintering step, the samples were subjected to a high pressure step, where Ar was introduced into the chamber during approximately 13 minutes to reach the pressure 55 bar, and thereafter holding this pressure for 15 minutes. The chamber was thereafter cooled down and the samples were removed from the chamber. The sintered samples were analyzed with regard to density and porosity. The results are presented in Table 2.

Powder B1 was sintered on Y-coated graphite trays in a DMK80 sintering furnace. First, the bodies were subjected to a debinding step where the temperature was increased from room temperature up to 550° C. in a sintering chamber with a H₂ flow of 500 I/hour. This was followed by a liquid phase sintering step where the temperature was increased from 550° C. to 1380° C. where it was hold for 30 minutes. Thereafter the temperature was increased to 1410° C. where it was hold for one hour. Thereafter the chamber was cooled down and the sintered samples removed from the chamber. The samples were then subjected to a sinter-HIP process including a step of holding the temperature at 1410° C. for 1 hour followed by a pressurized step where Ar was introduced into the chamber during approximately 13 minutes to reach the pressure 55 bar, and thereafter holding this pressure for 15 minutes. The chamber was thereafter cooled down and the sintered were samples removed from the chamber.

A cross section of each sintered and sinter-HIP processed sample was studied. Porosity was investigated by cemented carbide ABC-classification according to ISO 4499-4:2016.

TABLE 2
Printed pieces

| Powder | Density (g/cm³) | Porosity |
|---|---|---|
| A1 | 14.14 | A00B00C00 |
| A2 | 14.13 | A00B00C00 |
| B1 | 14.11 | A02B02C00 |

While the invention has been described in connection with the various exemplary embodiments, it is to be understood that the invention is not limited to the disclosed exemplary embodiments; on the contrary, it is intended to cover various modifications and equivalent arrangements within the scope of the appended claims.

1. A method of making a 3D printed cermet or cemented carbide body comprising a hard phase and a metallic binder phase, said method comprising the steps of:
providing a ready-to-print powder comprising cermet or cemented carbide particles;
3D printing a body using said ready-to-print powder together with a printing binder to form a 3D printed cermet or cemented carbide green body; and
sintering said green body in a sintering process including a liquid phase sintering step at a temperature for liquid phase sintering, wherein the sintering process includes at least one holding step prior to the liquid phase sintering step, wherein the duration of the holding step is between 30 and 500 minutes and the temperature for the holding step is between 1200 and (Tₘ−10)° C., where Tₘ is the temperature when the metallic binder phase starts to melt.

2. The method according to claim 1, wherein the sintering process includes a high pressure sintering step after the liquid phase sintering step.

3. The method according to claim 2, wherein the high pressure step is performed at a temperature of 1300-1500° C. and at a pressure of 20-100 bar.

4. The method according to claim 1, wherein the holding step is between 45 and 300 minutes and the holding temperature is between 1200 and 1300° C.

5. The method according to claim 1, wherein the liquid phase sintering in the vacuum sintering step takes place at a temperature of between 1350 to 1500° C.

6. The method according to claim 1, wherein the ready-to-print powder has a porosity of between 0 and 40%.

7. The method according to claim 1, wherein the ready-to-print-powder comprises between 10 to 70 vol % particles with a diameter of <10 μm.

8. The method according to claim 1, wherein the particle size distribution of the cemented carbide and/or cermet particles in the ready-to-print-powder is unimodal.

9. The method according to claim 1, wherein said metallic binder phase includes Co.

10. The method according to claim 1, wherein the ready-to-print powder is made by:
mixing a cermet or cemented carbide raw powder and organic binder;
spray drying the raw powder to form a granulated raw powder;
pre-sintering the spray dried raw powder and removing the organic binder to form a pre-sintered granulated powder; and
milling said pre-sintered granulated powder until the desired particle size distribution is achieved to form a ready-to-print-powder.

11. The method according to claim 1, further comprising, subsequent to 3D printing and before sintering, the steps of:
curing the 3D printed body in an inert atmosphere at 150-230° C.; and
depowdering the 3D printed body to remove loose particles from the surfaces of the body.

12. The method according to claim 1, wherein the sintering process includes a debinding step prior to the holding step, where the printing binder is burned off.

13. The method according to claim 1, wherein the three dimensional printing is binder jetting.

14. The method according to claim 1, wherein the body is a cutting tool for metal cutting or a cutting tool for mining application or a wear part.
